(19) United States
(12) Patent Application Publication
(10) Pub. No.: US 2022/0105721 A1
(43) Pub. Date: Apr. 7, 2022

(54) SERVICING PRINTING SYSTEMS

(71) Applicant: Hewlett-Packard Development Company, L.P., Spring, TX (US)

(72) Inventors: Andreu Vinets Alonso, Sant Cugat del Valles (ES); Antonio Gracia Verdugo, Sant Cugat del Valles (ES); Josep Maria Bel Calavia, Sant Cugat del Valles (ES); Jordi Bas Ferrer, Sant Cugat del Valles (ES)

(73) Assignee: Hewlett-Packard Development Company, L.P., Spring, TX (US)

(21) Appl. No.: 17/418,995

(22) PCT Filed: Jun. 5, 2019
(86) PCT No.: PCT/US2019/035475

§ 371 Date: Jun. 28, 2021

(51) Int. Cl. B41J 2/045; B41J 2/165

(52) U.S. Cl. CPC B41J 2/04561; B41J 2/0451; B41J 2/16579

(57) ABSTRACT

The present disclosure refers to servicing printing systems, wherein the system comprises a controller to: instruct an ejection of printing fluid from each of the nozzles within a printhead; detect, by a drop detector, drops ejected from each nozzle; determine by the controller a drop time for each nozzle, being the drop time determined between the instruction of the ejection of printing fluid from each of the nozzles until the drops ejected by each of the nozzles reaches the drop detector; and determine a nozzle health parameter in view of each nozzle drop time; wherein the method comprises comparing each nozzle health parameter with a threshold value and instructing, by the controller, a servicing operation if the nozzle health parameter is outside a threshold range.

### BACKGROUND

Various printing systems such as ink-jet printers may employ a printhead with nozzles that apply a quantity of printing fluid from the nozzles to specified pixel locations on a print medium. Such printheads may be coupled to a printing fluid supply. Some printing systems may comprise or may be couplable to servicing modules that may estimate or measure the status of the nozzles and perform servicing routines in view of their status.

There may be several printing routines that may be performed in view of the status of the nozzles, for example, for less severe cases it may be enough to modify printing or spitting parameters of the printheads to correct possible defects whereas, in more severe cases, a priming operation may be performed. Priming is an operation wherein a priming fluid is pressurized and expelled through the printhead to correct possible deficiencies on the printhead, e.g., to remove clogged ink in the nozzles of the printhead.

### BRIEF DESCRIPTION OF THE DRAWINGS

Various example features will be apparent from the detailed description which follows, taken in conjunction with the accompanying drawings, wherein:

FIG. 1 shows a schematic view of an example of printing system including a servicing module according to an example.

FIG. 2 shows a flowchart of a servicing method according to an example.

FIG. 3 shows a flowchart of a further servicing method according to an example.

FIG. 4 shows an example measurement of a nozzle health parameter for a set of nozzles.

FIG. 5 shows an example measurement of a nozzle health parameter for each of the nozzles within three printheads.

FIG. 6 shows an example of a measurement of a nozzle health parameter for all the nozzles within a printhead after performing a servicing method.

FIG. 7A and 7B show examples of a measurement of a nozzle health parameter within a printhead and its response at different firing frequencies.

### DETAILED DESCRIPTION

In the following description and figures, some example implementations of print apparatus, print systems, and/or methods of printing are described. In examples described herein, a “print apparatus” may be a device to print content on a physical medium (e.g., paper, textiles, a layer of powder-based build material, etc.) with a print material (e.g., ink or toner). For example, the print apparatus may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of printing fluids in a layer-wise additive manufacturing process. A print apparatus may utilize suitable print consumables, such as ink, toner, fluids or powders, or other raw materials for printing. In some examples, a print apparatus may be a three-dimensional (3D) print apparatus. An example of printing fluid is a water-based latex ink ejectable from a print head, such as a piezoelectric print head or a thermal inkjet print head. Other examples of printing fluid may include dye-based color inks, pigment-based inks, solvents, gloss enhancers, fixer agents, overcoats and the like.

In order to improve image quality on printing systems, users may want to have control over a larger number of printing parameters to be able to establish the adequate image quality needed in view of their specific requirements. The present disclosure discusses a method and a service module that monitors nozzle health and accommodates a servicing strategy in view of such nozzle health analysis.

In particular, the present disclosure refers to a servicing method for a printing system, wherein the method comprises:

instruct an ejection of printing fluid from each of the nozzles within a printhead;

detect, by a drop detector, drops ejected from each nozzle;

determine by the controller a drop time for each nozzle, being the drop time determined between the instruction of the ejection of printing fluid from each of the nozzles until the drops ejected by each of the nozzles reaches the drop detector; and

determine a nozzle health parameter in view of the drop time of each nozzle;

wherein the method comprises comparing each nozzle health parameter with a threshold value and instructing, by the controller, a servicing operation if the nozzle health parameter is outside a threshold range.

In an example, the nozzle health parameter comprises a drop velocity calculated in view of the drop time.

Further, the threshold range may be a determined range of drop velocities stored in a memory. Such range of drop velocities may be, in an example, static throughout a printing process. In other examples, the threshold range is a dynamic range calculated in view of the nozzle health parameters for the nozzles of a printhead.

In another example, the dynamic range is calculated as an average of the nozzle health parameters for the nozzles of a printhead.

Moreover, an example of a servicing operation may comprise modifying a print mask for the printhead. The servicing operation may also comprise triggering a priming of at least the nozzles with a nozzle health outside the threshold range

The present disclosure also refers to a servicing module for a printing system comprising:

a drop detector to detect drops ejected from a plurality of nozzles and issue a drop detection signal; and

a controller to receive the drop detection signal; wherein the controller is to calculate a drop time for each of the plurality of nozzles in view of the drop detection signal and to determine a nozzle health parameter for each nozzle in view of the drop time.

In an example, the drop detector comprises an optical sensor.

Further, the controller may, in an example, comprise a memory to store a threshold range, wherein the controller is to compare the nozzle health parameters with the threshold range, and wherein the controller is to perform a servicing operation upon determination that the nozzle health parameter is outside a threshold range.

In an example, the threshold range is a dynamic range calculated in view of the nozzle health parameters for the nozzles of a printhead. For example, the dynamic range may be calculated as an average of the nozzle health parameters for the nozzles of a printhead.

As for the servicing operation, in an example, such operation is at least one of: modifying a print mask or priming at least some of the nozzles.

Also, it is herewith disclosed a non-transitory machine readable medium storing instructions executable by a controller, the medium storing instructions to control a printing system to perform a servicing method according to the above-mentioned features.

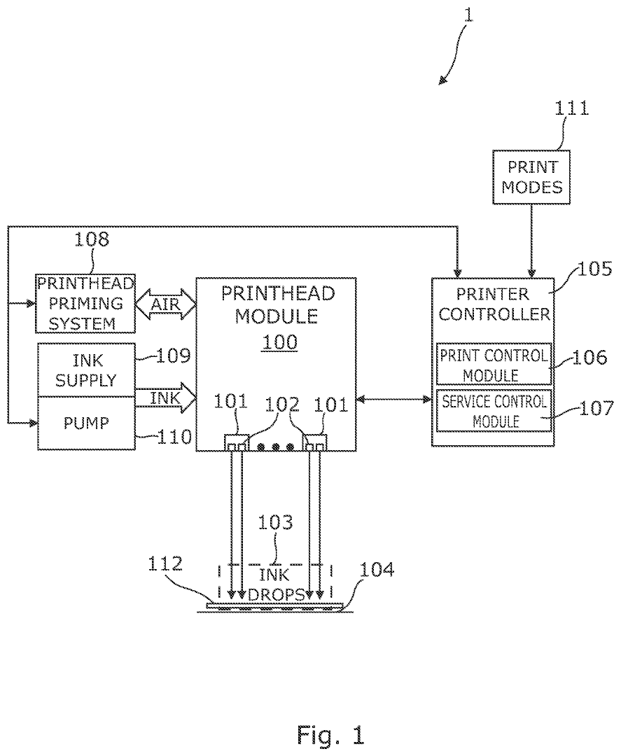

FIG. 1 shows an example of a printing system 1 that includes a servicing module comprising a drop detector 112, a printhead priming system 108, and a service control module 107. Further, the printing system 1 includes a printhead module 100 that, in turn, comprises a set of printheads 101, each of them including a plurality of nozzles 102 that are to eject ink drops 103 as to form an image in a media 104. The printhead module 100 is to receive printing fluid that, in an example, may be an ink from an ink supply 109 by means of a pump 110. Even thought in the example of FIG. 1 the drop detector detects drops as they travel towards the media, in other examples, the drop detector is positioned outside the media path in a servicing area.

The drop detector 102 may be used to determine a nozzle health parameter for each of the nozzles within a printhead 101. For example, the drop detector 102 may be to determine the elapsed time between an instruction to eject a drop from the nozzle until the drop reaches the drop detector. Such elapsed time may also be referred to herein as a drop time and may be used to determine drop velocity.

Drop time and/or drop velocity may be used as nozzle health parameters, for example, in case a fluid different from a printing fluid associated to a determined nozzle is being ejected by it, such drop health parameter is likely to change due the different composition of the fluid being ejected by the nozzle e.g., having a different drop weight and, in consequence, a different nozzle health parameter associated to a different drop velocity. Therefore, the nozzle health parameter may be useful to determine, amongst others, an undesired printing fluid mixture within the printheads 101.

Also, in some printing systems, printers are shipped with a shipping fluid different from the printing fluid that may be, e.g., more stable to changes in pressures. During set-up of the printer, it is recommended to ensure that all of the shipping fluid has been removed from the printheads 101 before printing an actual job. In this case, the nozzle health parameter may also be useful to determine when the shipping fluid, that is normally more viscous and, therefore, having a higher drop velocity, is entirely expelled from the printheads 101.

Another use of the nozzle health parameter may be to identify issues with a determined section of a printhead 101, for example, in some printhead architectures, the fluid conduits through which the printing fluid passes may be more prone to the presence of clots or other artifacts on the edges of the printhead or in the nozzles associated to such edges. In these cases, the nozzle health parameter may be used to determine if a determined zone of the printhead has a different behavior and take appropriate servicing actions to mitigate the effect of these issues in printing quality.

To solve nozzle issues including those mentioned above, the printing system 1 may be provided with several tools to help improve nozzle health. In an example, the printhead module 100 includes a printhead priming system 108 that is to provide air to the printhead module and force the ejection of fluid from the printheads 102 at a higher pressure than during a normal printing operation. Alternative, less severe tools may include changing printing parameters for nozzles with a nozzle health parameter outside a determined threshold, for example, the service control module 107 may provide an input to the print control module 106 within the printer controller 105 to select a different print mode 111 as to overcome possible issues with a nozzle. The print mode may be selected for a determined period of time and then return to a previous print mode or may be maintained, e.g., through a whole print job or until a next evaluation of the nozzle.

In addition or instead of the above-mentioned operations, the service control module 107 may be to determine parameters for servicing spitting. Servicing spitting is an operation wherein the printer is to print on a determined zone a servicing image that is not part of the print job. Normally these servicing images are printed on the edges of the media or in a spittoon remote to the media.

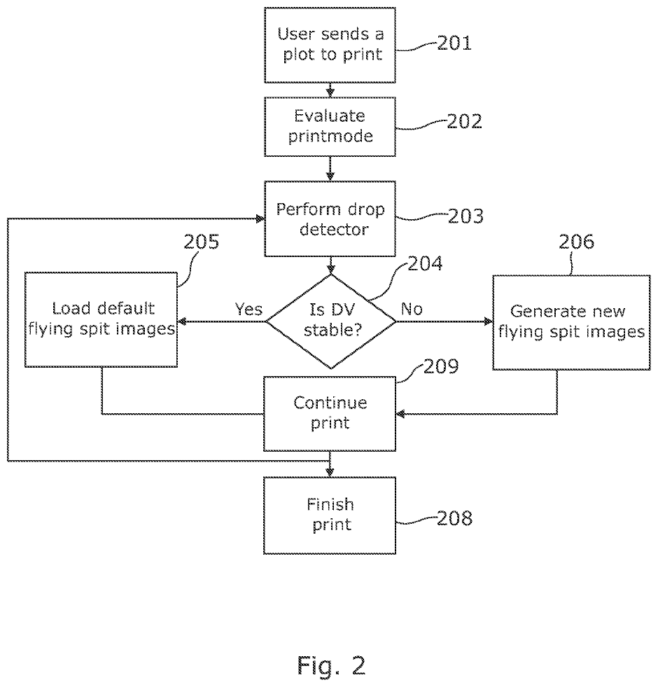

FIG. 2 shows an example of a method wherein the user selects print data and sends it to a printer 201, once in the printer, it analyses the print mode 202 to be used to print the print data. In an example, the printer may be to select the appropriate print mode depending on the print data and select the appropriate print parameters to use during the print job. This can be performed, e.g., by means of a printer controller 105 and, in particular, by the print control module 106 of the printer controller 105.

In the method of FIG. 2, the controller 105 may be configured to check nozzle status. For this purpose, the printer executes drop detection 203 wherein the controller instructs each of the nozzles to eject printing fluid through a detection area of the drop detector. The drop detector performs a detection for each nozzle and communicates such detection to a controller, and the controller determines the time elapsed between the instruction to eject printing fluid and the detection of the drop, i.e., the drop time.

In an example, the drop detector is an optical sensor including an optical emitter to emit a light beam and a receiver such as, e.g., a photodetector. The drop detector determines that a droplet is present by detecting an interruption of the light beam in the receiver side or, at least, a decrease in the intensity of the received light beam. Other types of drop detectors may include, e.g., image acquisition devices such as high-speed cameras.

Once the controller has acquired the data from the drop detector for each of the nozzles, the controller may determine a nozzle health parameter for each nozzle. In an example, the controller may use the drop time as nozzle health parameter or determine the drop velocity for each of the nozzles.

Then the controller may evaluate whether the nozzle health parameter is within a predetermined threshold 204. In an example, the predetermined threshold may be a static threshold such as a fixed nozzle health parameter or may be a parametric threshold calculated in view of other nozzles within the printhead. Examples of parametric thresholds may be a threshold calculated in view of a mathematical operation amongst the nozzle health parameter for several nozzles within the same printhead, e.g., an average value.

If the nozzle health parameter for most of the nozzles is within the threshold, then print mode selected on block 202 may be maintained and, e.g., default servicing images may be loaded for service spitting 205.

In case the health parameter for some of the nozzles is not within the threshold, at least a parameter of the print mode may be modified 206, for example, the service images may be modified, e.g., by printing a different shape including more spitting area and/or using a different firing frequency on at least some of the nozzles. In case nozzles within a determined area of the printhead are outside the threshold, for example, a set of problematic nozzles in the proximity of an edge of the printhead, then a different firing frequency for these problematic nozzles on the servicing image and/or the print job may be modified.

Then, the method continues 207 printing the print job and performs periodic re-evaluation of the nozzles and determination of the print parameters until the print is finished 208. In an example, the period for re-evaluation is a set period such as every N swaths or jobs, for example, every 5 jobs in case of scanning printheads. In other examples, the determination of the period may be time-based, e.g., every two hours or at specific times, e.g., every night.

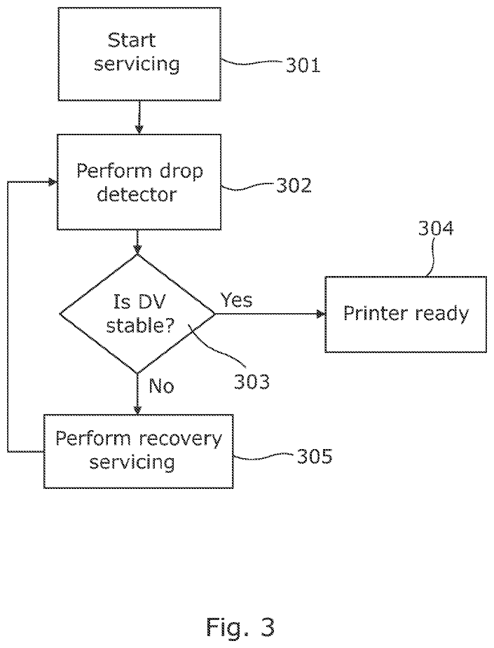

FIG. 3 shows a further example method according to the present disclosure. FIG. 3 discloses a method wherein a servicing operation is started 301, for example, to remove shipping fluid from a printhead before a first use of the printer. Nonetheless, this method can also be applied to solve other issues on the printheads, e.g., mixed printing fluids, nozzle clogging, etc.

The method comprises performing a drop detection routine 302 wherein a nozzle health parameter is gathered, for example, drop time or drop velocity. Then, it is determined if the nozzle health parameter is within a threshold 303, for example, if the nozzle health parameters for substantially all nozzles within the printhead are substantially stable, i.e., being within a determined tolerance from the average nozzle health parameter across the printhead.

If the nozzle health parameters are stable, then the printer is ready for use 204. Otherwise, the printer may need to perform some servicing 305, e.g., a priming operation wherein the printhead is fed with pressurized air to remove shipping fluid or any artefacts within the printhead. Alternatively, other servicing operations may be performed, e.g., servicing spitting, or modifying print parameters to improve nozzle performance for nozzles being outside the threshold.

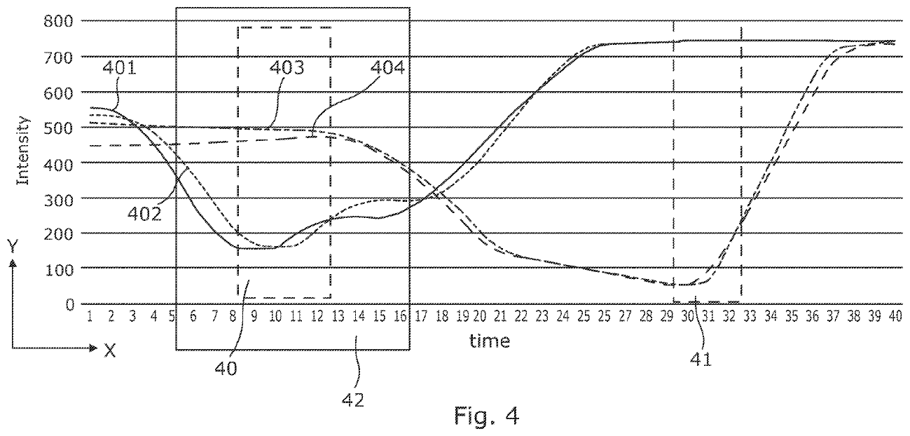

FIG. 4 shows an example of measurements obtained by the drop detector for an instruction to expel a droplet by a first nozzle 401, a second nozzle, 402, a third nozzle 403 and a fourth nozzle 404. In particular, drop times are to be identified.

In the figure, the Y axis represents the intensity of the drop detector signal being the drop detector an optical sensor wherein a lower intensity represents an interruption of a light beam and, therefore, a pass of a drop. The X axis represents time in measurement steps. Therefore, the measurement performed is a drop time that may be associated to printhead characteristics such as, e.g., the drop volume expelled by a nozzle and/or the drop velocity.

As can be seen, for the measurements performed, the first and second nozzles 401, 402 show a minimum within a first time frame 40 whereas the third and fourth nozzles show a minimum in a second time frame 41 that is later in time than the first time frame 40. After the minimum, the intensity received increases until it reaches a non-detection state with a high intensity.

For this printhead, it has been established a nozzle health parameter threshold 42 associated to the drop time. As explained above, the threshold 42 may be a predefined threshold or a threshold obtained through a computation of the measurements obtained for a printhead or for a plurality of printheads, e.g., averages, means, standard deviations, etc.

A conclusion that may be read from the measurements obtained for FIG. 4 is that the first and second nozzles 401, 402 have a drop velocity within the thresholds and no action is needed on them. On the other hand, the third and fourth nozzles 403, 404 are problematic and show a low drop velocity and maintenance routines may be performed on such problematic nozzles, e.g., increasing the firing frequency of such nozzles while performing servicing by spitting, increase the firing frequency while printing a job or performing a priming operation of the printhead.

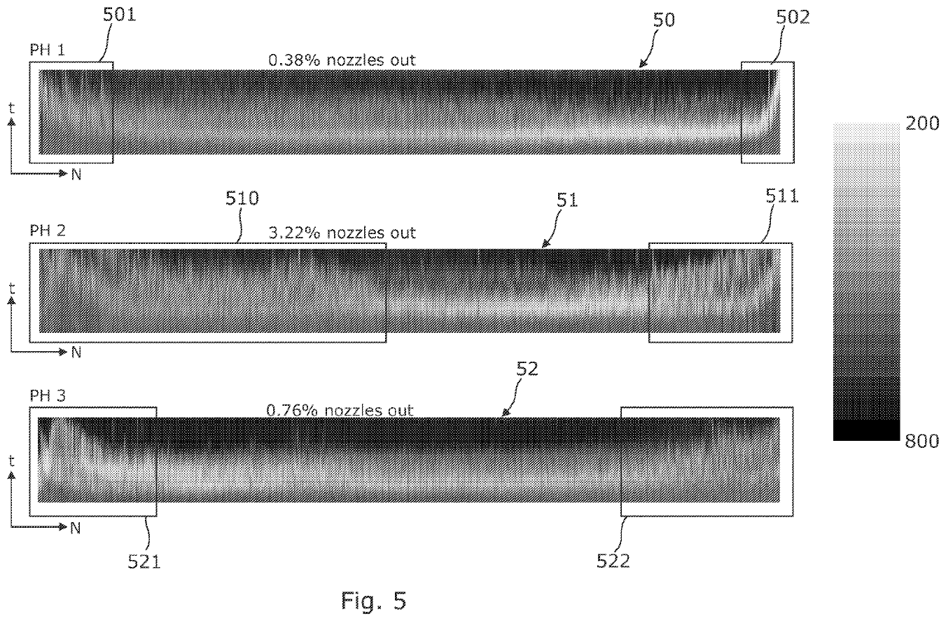

FIGS. 5, 6, 7A and 7B show drop detector graphs for printheads being the drop detector an optical drop detector. The Y axis represents drop time, the X axis represents the nozzle number of the printhead and the greyscale represents beam intensity on the receiver side of the drop detector.

FIG. 5 shows measurements of the drop detector obtained for three printheads that may be to expel a colorant, e.g., black ink as printing fluid, namely,

“PH 1” 50, “PH 2” 51, and “PH 3” 52. Nonetheless similar principles apply to other printing fluids and the present disclosure would be applicable as well to them.

In the example of FIG. 5, the three printheads 50, 51, 52 has been shipped with shipping fluid and a priming routine has been performed on the printheads to expel the denser shipping fluid and replace it with printing fluid. After the priming routine, a drop detector has been used to determine the status of the newly installed printheads. In this case, it can be seen that the areas associated to the edges 501, 502, 511, 512, 521, 522 of each of the printheads 50, 51, 52 are having lower drop velocities. In this case, the most severe issues are on the second printhead 51 with a 3.22% of nozzles out. In the context of the present disclosure a nozzle out is not a completely defective nozzle but simply a nozzle that has a certain abnormality.

Therefore, it is considered that several of the nozzles are not within nozzle health parameter threshold and a servicing routine may be needed. In this case, a further priming routine to ensure drop velocity stability across the printheads. In particular, that the nozzle health parameter associated to the drop time is within the determined threshold for most (or all of) the nozzles.

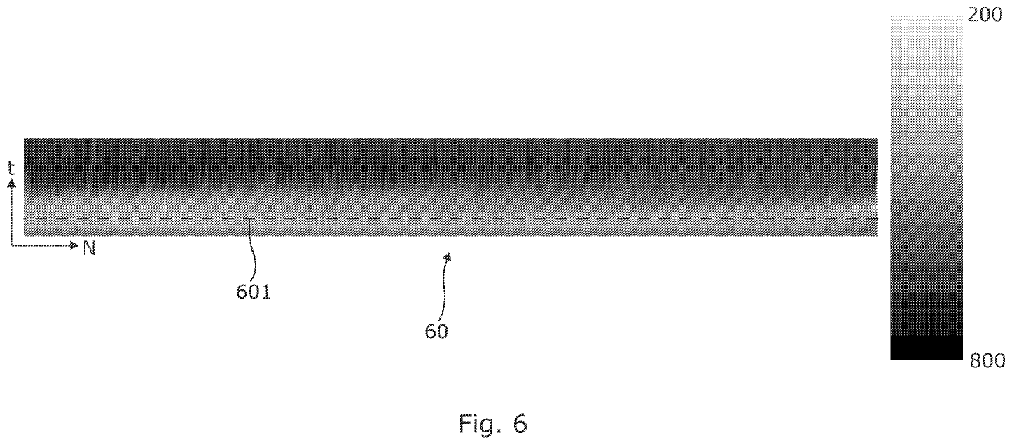

FIG. 6 shows an example of one of the printheads with an appropriate drop velocity stability across a printhead wherein substantially all of the shipping fluid has been expelled. In particular, the drop detector signal 60 associated to printhead shows 0% nozzles out, i.e., that all of the nozzles are within an accepted tolerance from the nozzle health parameter threshold 601.

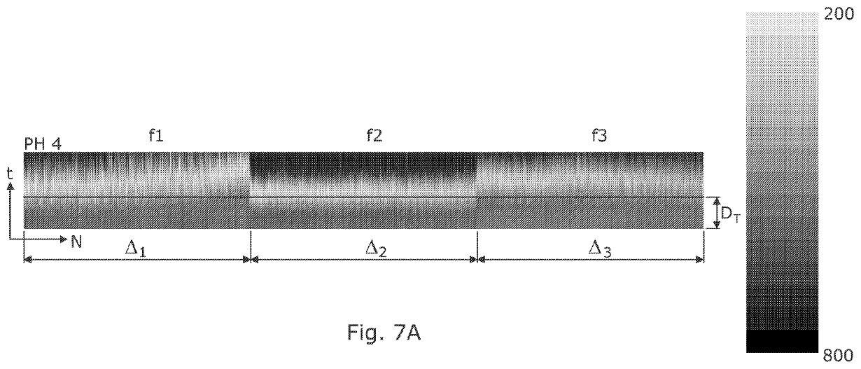

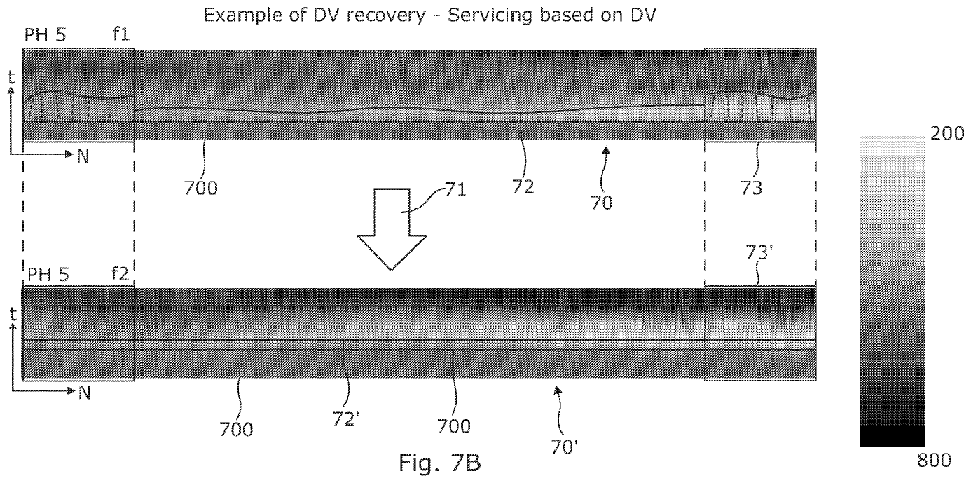

FIG. 7A shows drop detector measurement performed on a printhead PH 4 while the nozzle is instructed to expel printing fluid at three different firing frequencies, a first firing frequency (f1), a second firing frequency (f2) and a third firing frequency (f3) being the first firing (f1) frequency a lower frequency than the second firing frequency (f2) and the second firing frequency (f2) higher than the third firing frequency (f3).

In the first measurement Δ₁, it can be seen that the printhead while firing at the first firing frequency below 5 kHz has substantial variation between the different nozzles, being the nozzles of the rightmost side more severely affected by the variation and being outside the tolerances from the nozzle health parameter threshold D_{T} by a bigger magnitude than the rest of the printhead. These measurements can be indicative of poor image quality due to drop positioning variability.

In the third measurement Δ₃, the printhead is instructed to fire with a firing frequency between 5 kHz and 10 kHz and the findings are less variability amongst the nozzles of the printhead but most of the nozzles fire with a drop velocity that is slower than the drop threshold D_{T}.

In the second measurement, with the printhead being instructed to fire at a frequency between 10 kHz and 15 kHz, the nozzle health parameter improves and substantially all the nozzles are within an acceptable tolerance from the drop threshold D_{T}.

In consequence, a controller used to determine the firing frequency associated to the nozzles in view of the drop detector measurements for nozzle health parameters, may be used to improve image quality, e.g., by increasing the firing frequency. In an example, the controller may be provided with a default firing frequency and a recovery firing frequency higher than the default frequency and, upon detection that at least some nozzles within the printhead have a nozzle health parameter outside a threshold, i.e., the nozzles are identified as problematic, the controller may switch the firing frequency for at least the problematic nozzles from the default firing frequency to the recovery firing frequency. Further, the switch to the recovery firing frequency may be performed only for printing servicing images or for the entire print job.

The recovery frequency is, in an example, a frequency above 10 kHz.

FIG. 7B shows an example of results obtained by using a maintenance routing in view of a measurement of a nozzle health parameter with the drop detector.

In particular, FIG. 7B shows a first measurement 70 performed on a printhead while being instructed to perform a drop detection after expelling a determined printing fluid at a default firing frequency.

In this case, the drop time can be taken as the nozzle health parameter. As seen in the figure, the drop time 72 for the nozzles is slightly above a drop time threshold 700 for most of the nozzles. This means that substantially all nozzles have a slow drop velocity. Further, the nozzles associated to the extremes of the printhead 72, 73 have a higher variability between nozzles, i.e., the points with less intensity (whiter in the image) are located within broad detection areas 720, 730. This higher variability also has an impact on image quality.

To solve the above-mentioned issues, the controller may perform a servicing routine 71, e.g., by the controller modifying printing parameters, that help provide:
a. Stability between drops, i.e., that the detection areas are substantially narrow and stable along the printhead
b. Better drop velocity, i.e., that the drop time is substantially within a threshold.

Once a print parameter has been changed triggered by the servicing routine 71, e.g., a change in the firing frequency, a second measurement 70′ is performed for the same printhead.

The results of the change of the firing frequency achieve that the drop velocity 72′ is now closer to the threshold 700 and within a lower tolerance from it and, also, the variability within drops, i.e., the changes in the drop detection time for each of the nozzles is substantially stable along the printhead.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teachings. It is to be understood that any feature described in relation to any one example may be used alone, or in combination with other features described, and may also be used in combination with any features of any other of the examples, or any combination of any other of the examples.

1. A servicing method for a printing system, wherein the method comprises:
instruct an ejection of printing fluid from each of the nozzles within a printhead;
detect, by a drop detector, drops ejected from each nozzle;
determine by the controller a drop time for each nozzle, being the drop time determined between the instruction of the ejection of printing fluid from each of the nozzles until the drops ejected by each of the nozzles reaches the drop detector; and
determine a nozzle health parameter in view of the drop time of each nozzle;
wherein the method comprises comparing each nozzle health parameter with a threshold value and instructing, by the controller, a servicing operation if the nozzle health parameter is outside a threshold range.

2. The method of claim 1 wherein the nozzle health parameter comprises a drop velocity calculated in view of the drop time.

3. The method of claim 2, wherein the threshold range is a determined range of drop velocities stored in a memory.

4. The method of claim 3 wherein the range of drop velocities is static throughout a printing process.

5. The method of claim 1 wherein the threshold range is a range calculated in view of the nozzle health parameters of a plurality of nozzles within the printhead.

6. The method of claim 5 wherein the threshold range is associated to an average of the nozzle health parameters of the printhead.

7. The method of claim 1 wherein the servicing operation comprises modifying a print mask for the printhead.

8. The method of claim 1 wherein the servicing operation comprises triggering a priming of at least the nozzles with a nozzle health outside the threshold range

9. A servicing module for a printing system comprising:
a drop detector to detect drops ejected from a plurality of nozzles and issue a drop detection signal; and
a controller to receive the drop detection signal;
wherein the controller is to calculate a drop time for each of the plurality of nozzles in view of the drop detection signal and to determine a nozzle health parameter for each nozzle in view of the drop time.

10. The module of claim 9 wherein the drop detector comprises an optical sensor.

11. The module of claim 9 wherein the controller comprises a memory to store a threshold range, wherein the controller is to compare the nozzle health parameters with the threshold range, and wherein the controller is to perform a servicing operation upon determination that the nozzle health parameter is outside a threshold range.

12. The module of claim 11 wherein the threshold range is a dynamic range calculated in view of the nozzle health parameters for the nozzles of a printhead.

13. The module of claim 12 wherein the dynamic range is calculated as an average of the nozzle health parameters for the nozzles of a printhead.

14. The module of claim 9 wherein the servicing operation is at least one of:
modifying a print mask or priming at least some of the nozzles.

15. A non-transitory machine readable medium storing instructions executable by a controller, the medium storing instructions to control a printing system to perform a servicing method according to claim 1.
